(19) United States
(12) Patent Application Publication
(10) Pub. No.: US 2026/0280184 A1
(43) Pub. Date: Sep. 17, 2026

(54) ELECTRICAL CONNECTOR

(71) Applicant: SAFRAN ELECTRICAL COMPONENTS, LOCHES (FR)

(72) Inventors: Yannick PELLETIER, MOISSY-CRAMAYEL (FR); Daphné BERTHIER, MOISSY-CRAMAYEL (FR); Ophélie PETIT, MOISSY-CRAMAYEL (FR)

(73) Assignee: SAFRAN ELECTRICAL COMPONENTS, LOCHES (FR)

(21) Appl. No.: 19/469,007

(22) PCT Filed: Mar. 28, 2024
(86) PCT No.: PCT/FR2024/050402

§ 371 Date: Sep. 25, 2025

(30) Foreign Application Priority Data
Mar. 30, 2023 (FR) FR2303105

(51) Int. Cl. H01R 13/53; H01R 13/52; H01R 24/20; H01R 24/28; H01R 24/38

(52) U.S. Cl. CPC H01R 13/53; H01R 13/5219; H01R 24/20; H01R 24/28; H01R 24/38; H01R 2201/26

(57) ABSTRACT

An electrical connector includes a hollow cylindrical body extending around an axis of revolution, an electrical contact, and an annular insulator. The annular insulator has a shape that is complementary to that of the electrical contact and is in contact with the outside of the surface of the electrical contact over the entire longitudinal extent thereof except for a portion of the surface of the electrical contact that is intended to make contact with an electrical contact of a complementary electrical connector. The annular insulator further comprises a first annular insulator which covers a connection area of the electrical contact and is made of glass-ceramic.

### TECHNICAL FIELD

The invention relates to the field of electrical connection devices for the high-power transmission in an aircraft. It relates in particular to an electrical connector for establishing an electrical connection with a complementary electrical connector, and an assembly comprising two complementary electrical connectors.

### PRIOR ART

The prior art comprises the documents WO-A1-2014183115, U.S. Pat. No. 2,824,290, EP-A1-3364504 and FR-A1-3110781.

The current efforts to decarbonize aircrafts are leading to more and more electrical systems being integrated into them. The hybridization or the electrification of aircrafts is part of this trend, and is giving rise to a new need for high-power electrical connectors, i.e. those capable of withstanding high voltages and currents.

The preferred approach for achieving high power levels mainly involves increasing voltage levels within aircraft onboard networks, since increasing current levels would require larger conductor cross-sections and therefore greater weight, which runs counter to the objectives sought for use in an aircraft.

Thus, the voltages currently envisaged for on-board aircraft networks are in the region of 800 to 1,000 Volts (DC voltage), but could eventually rise to 3,000 Volts for currents of around 500 Amperes.

Such voltage and current values, combined with use at high altitudes (e.g., 55,000 feet), which involves significant variations in temperature (e.g., ranging from −55° C. to +250° C.), pressure, and humidity, lead to the occurrence of physical phenomena that are rare or otherwise non-existent.

Thus, a known phenomenon associated with such conditions of use is partial discharge. This is a localized discharge resulting from temporary ionization of a gas in an electrical insulation system, which occurs when the electrical stress (electric fields) exceeds a critical value.

This phenomenon is critical in that it can lead to reduced performance and deterioration of an electrical system in which it occurs.

In the case of electrical connectors, the occurrence of partial discharges within them can damage the insulators contained in the connectors (i.e., accelerate their aging) and even, in the long term, cause a short-circuit, rendering the connector inoperable. In particular, when used in an aircraft, where an electrical connector is subject to significant variations in temperature and pressure (due to altitude), the partial discharges can cause an insulation fault in the connector, resulting in the activation of protection devices and cutting off the power supply to loads in the aircraft's electrical system (engines, actuators, etc.).

For these reasons, in the current prior art, the electrical connectors intended for aeronautical use are replaced by terminal blocks when they are to be used for high power applications.

In addition, the existing electrical connectors are limited to operating voltages of between 28 Volts DC and 115 Volts AC on the one hand, and +/−270 Volts DC and 230 Volts AC on the other. These operating voltages values do not generate partial discharges, even when used in an aircraft at altitude.

In these electrical connectors, the electrical insulators used are made in particular from dielectric materials, i.e. materials containing no free charge capable of conducting electrons. Since the electricity needs to transfer the electrical charges that make it up in order to be conducted, this type of material is insulating, since it prevents this conduction.

In addition, for the electrical connectors specifically designed for high-power transfer, elastomers, glass, air, or polymers are commonly used as insulators. However, although they are good electrical insulators, these materials have major disadvantages for high-power applications.

Indeed, the elastomers and polymers have a non-zero porosity, which results from their manufacture and can reduce their insulating performance (to the point of making these materials conductive in some cases, for example when they are contaminated with impurities).

The use of air as an insulator requires significant thicknesses to achieve effective electrical insulation. Furthermore, at high altitudes, the conductivity of water contained in the air can increase to levels that are detrimental to the performance of the insulator.

The glass, on the other hand, has a permittivity that is too high compared to the other materials mentioned.

In general, these closed-cell materials do not allow for quick, non-destructive verification of the porosity of the manufactured pieces.

In addition, all these materials have low thermal conductivities (e.g. around 0.4 W/m·K for an elastomer or 0.3 W/m·K for a composite material).

The low thermal conductivity of these materials has the disadvantage of containing these very significant temperature increases, particularly for high-power applications. However, the impact of poor heat dissipation (resulting from low thermal conductivity) is also premature degradation of the components of the electrical connectors.

Finally, the porosity of these materials leads to the existence of partial discharges. In particular, when used at high power, partial discharges are established in the cavities of the porous material and can migrate from cavity to cavity until the electrical insulation function is lost due to the appearance of an arc path. For example, a cavity larger than 17 micrometers is sufficient to cause premature aging of the electrical insulation through erosion.

The degradation of the insulation leads to carbon deposits in the cavities (due to porosity). These deposits can gradually generate conductive paths, creating an electric arc and, over time, eventually causing a short circuit. Given the voltage and current levels applied in the electrical connectors (for high-power use), there is a significant risk of short-circuit or even fire.

### SUMMARY OF THE INVENTION

The present invention proposes a solution to these disadvantages.

Thus, one objective of the invention is to obtain an electrical connector using an insulator whose shape and material(s) reduce the risk of partial discharges during high-power use while allowing for good heat dissipation.

To this end, the invention according to a first aspect relates to an electrical connector for establishing an electrical connection with a complementary electrical connector, said electrical connector comprising:
a hollow cylindrical body extending around an axis of revolution;
at least one electrical contact positioned inside the hollow cylindrical body and extending parallel to the axis of revolution;
at least one annular insulator, extending parallel to the axis of revolution and being positioned radially between said at least one electrical contact and the hollow cylindrical body,
   said electrical connector being characterized in that, over its entire longitudinal extent, said at least one annular insulator has a shape that is complementary to the shape of said at least one electrical contact and externally covers a surface of said at least one electrical contact, with the exception of a part of said surface of said at least one electrical contact that is configured to make contact with an electrical contact of the complementary electrical connector,
   and in that said at least one annular insulator comprises a first annular insulator, made of a glass ceramic, covering a connection area of said at least one electrical contact.

The electrical connector according to the invention may comprise one or more of the following characteristics, taken in isolation from each other or in combination with each other:
said at least one annular insulator further comprises a second annular insulator, made of an elastomer, preferably silicone, covering a conduction area of said at least one electrical contact.
the electrical connector is of the socket type and said at least one electrical contact is electrically connected to a bus bar or an electrical cable, or the electrical connector is of the plug type and said at least one electrical contact is electrically connected to an electrical cable or a bus bar.
said at least one electrical contact is of the male type.
said at least one electrical contact is of the female type.
the electrical connector further comprises at least one flat elastomeric gasket positioned at a second surface of said at least one radially extending electrical contact at the interface between said at least one electrical contact and said at least one first annular insulator.
said at least one first annular insulator further comprises, over all or part of its surface at the interface with the hollow cylindrical body, a layer of electrically conductive material.
the glass ceramic in which the first annular insulator is made is a zero-porosity ceramic.

The invention according to a second aspect also relates to an assembly comprising two complementary electrical connectors according to the first aspect.

Finally, the invention according to a third aspect concerns an aircraft comprising an assembly of electrical connectors according to the second aspect.

### BRIEF DESCRIPTION OF FIGURES

The invention will be better understood with the aid of the following description, given only by way of example and made with reference to the attached drawings wherein:

FIG. 1 is a schematic representation of an embodiment of an assembly comprising two electrical connectors according to the invention;

FIG. 2 is an illustration of an embodiment of annular insulators for an electrical connector according to the invention;

FIG. 3 is an illustration of an embodiment of annular insulators for an electrical connector according to the invention;

FIG. 4 is an illustration of an embodiment of annular insulators covering electrical contacts according to the invention;

FIG. 5 is a schematic representation of an embodiment of an assembly comprising two electrical connectors, with a representation of the leakage lines, according to the invention;

FIG. 6 is a schematic representation of an embodiment of an assembly comprising two electrical connectors, with a representation of the positioning of at least one flat elastomer seal, according to the invention;

FIG. 7 is an illustration of an embodiment of annular insulators covered with a layer of electrically conductive material for an electrical connector according to the invention;

FIG. 8 is an illustration of an embodiment of annular insulators covered with a layer of electrically conductive material for an electrical connector according to the invention; and,

FIG. 9 is a cross-sectional profile view of an embodiment of an electrical connector assembly where the hollow cylindrical body is covered with a layer of polymer over all or part of its radially inner surface.

### DESCRIPTION OF THE EMBODIMENTS

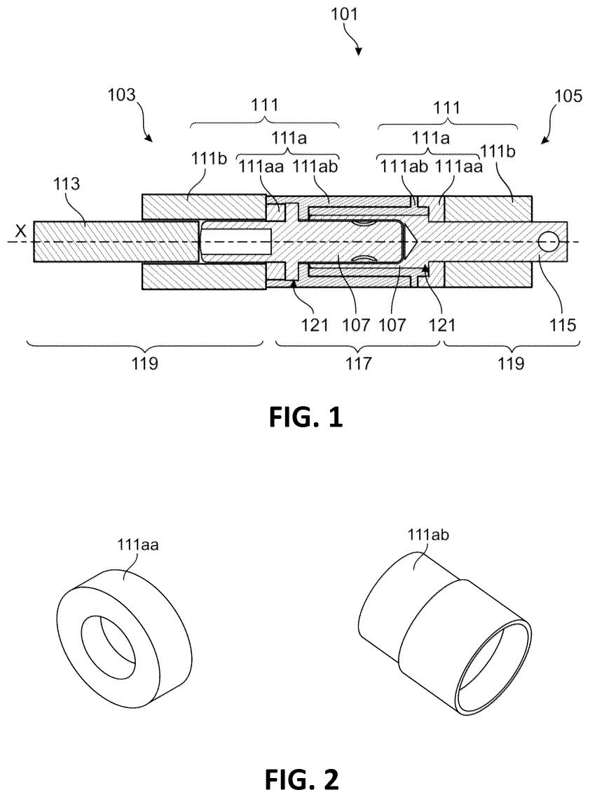

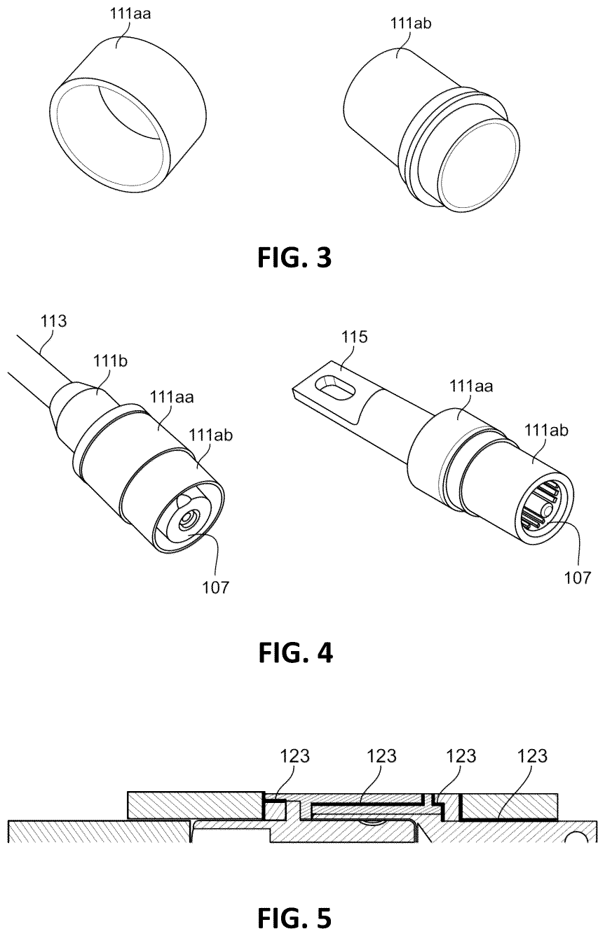

With reference to FIGS. 1 to 4, we will now describe an embodiment of an assembly 101 comprising two complementary electrical connectors 103 and 105 according to the invention.

The example shown in these figures relates more specifically to an assembly 101 comprising two complementary electrical connectors 103 and 105, which are respectively a plug, comprising a male electrical contact 107, and a socket, comprising a female electrical contact 107. In addition, in the example shown in FIG. 1, the two electrical connectors 103 and 105 are assembled.

The term “complementary” here means that each electrical connector is complementary to the other in that it is configured to fit into the other so as to be held together (for example via clamping means) and make an electrical connection. In addition to the non-limiting example shown in these figures, in general, the invention described below applies equally to both socket-type and plug-type electrical connectors, in which the electrical contact is electrically connected to a bus bar (for example, by forming a single piece with this bus bar) or to an electrical cable (for example, by crimping the electrical cable into the electrical contact).

Similarly, the invention applies to an electrical connector, in which the electrical contact may be either male or female. For example, a male electrical contact may generally be shaped like a stud, while a female electrical contact may generally be shaped like a hole, complementary to the shape of the stud, to allow these conductive elements to fit together.

The electrical connectors described below may be, for example, so-called high-power electrical connectors (also known as power connectors), i.e., electrical connectors configured to withstand a DC voltage greater than or equal to 800 volts and a current greater than or equal to 500 amps. These may include electrical connectors used for the high-power transmission in an aircraft.

Thus, the assembly 101 shown in FIG. 1 comprises two connectors 103 and 105. Each electrical connector 103 or 105 is configured to establish an electrical connection with the other electrical connector 105 or 103, which is said to be complementary.

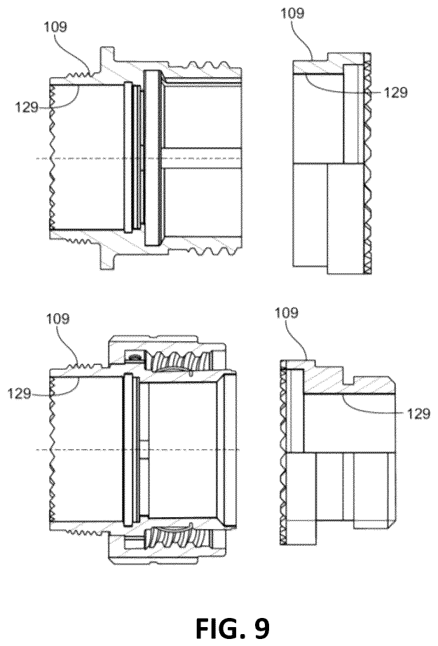

Each connector 103 and 105 comprises a hollow cylindrical body 109 which extends around an axis of revolution X. This hollow cylindrical body 109, for example made of metal (e.g. stainless steel or aluminium), is not shown in FIG. 1 but is shown in FIG. 9.

Throughout the following, the “longitudinal” and “radial” directions are defined with reference to said axis of revolution of the connector.

Each connector 103 and 105 also comprises an electrical contact 107 which is positioned inside the hollow cylindrical body 109 and extends parallel to the axis of revolution X.

Finally, each connector 103 and 105 comprises an annular insulator 111, which extends parallel to the axis of revolution X and is positioned radially between the electrical contact 107 and the hollow cylindrical body 109.

In the non-limiting example shown, each electrical connector 103 and 105 comprises a single electrical contact 107, however the invention also applies to an electrical connector which comprises a number of electrical contacts greater than or equal to 1 and one or more annular insulators surrounding these electrical contacts.

Furthermore, in the non-limiting example shown, the electrical contact 107 of the electrical connector 103 is electrically connected to an electrical cable 113 (in this case by crimping the electrical cable 113 into the electrical contact 107) whereas the electrical contact 107 of the electrical connector 105 is electrically connected to a bus bar 115 (in this case by forming a single piece with it).

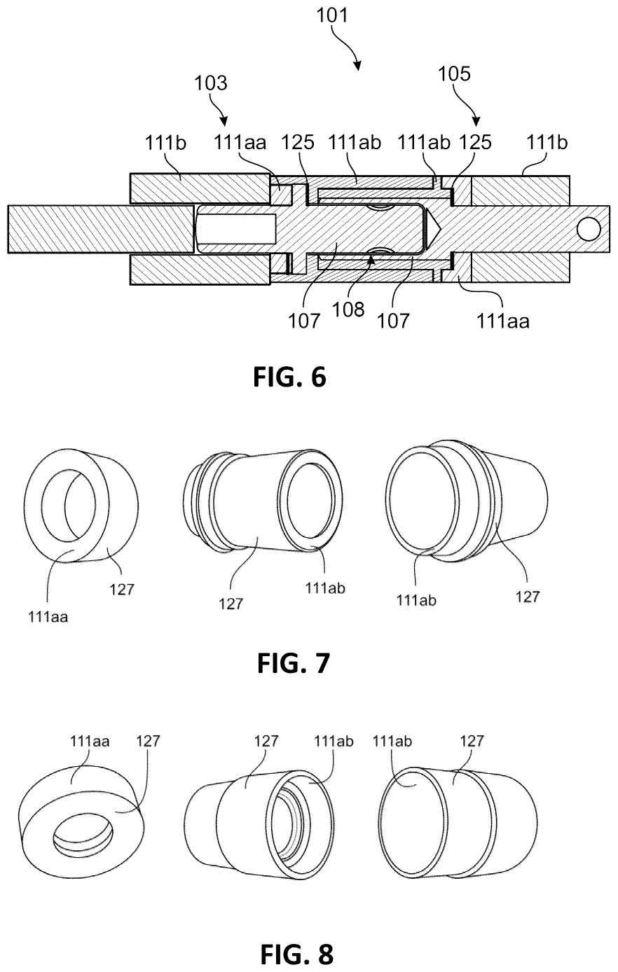

The annular insulator 111 has a shape complementary to the shape of the electrical contact 107 and covers its surface (i.e. the outer surface of the electrical contact) over its entire longitudinal extent (that of the annular insulator) except for the part 108 of the surface (visible in FIG. 6) of the electrical contact 107 configured to make contact with an electrical contact of the complementary electrical connector.

In addition, the annular insulator 111 comprises a first annular insulator 111a, which is made of a glass ceramic and which covers a connection area 117 of the electrical contact 107.

For each electrical connector 103 and 105, the connection area 117 designates the part of the longitudinal extension of the electrical contact 107, and by extension the part of the longitudinal extension of the electrical connector itself, which is intended to establish contact between two electrical connectors, in particular by inserting a male electrical contact 107 into a female electrical contact 107.

The glass ceramic can be, for example, a zero-porosity type ceramic, i.e. a ceramic that has high electrical insulation properties, while having zero porosity induced by its manufacture. One example is Macor®, a ceramic composed of 55% fluorophlogopite and 45% borosilicate glass.

In addition, the glass ceramic is known for its high dielectric strength and for being naturally resistant to aging induced by the possible occurrence of partial discharges in air cavities (or vacuoles).

Furthermore, the glass ceramics also act as thermal conductors, as they have higher thermal conductivity than the materials used in the prior art and therefore prevent excessive temperature rises.

Finally, the glass ceramic itself is resistant to temperatures in excess of 800° C.

In the non-limiting example shown, the annular insulator 111 also comprises a second annular insulator 111b, made of an elastomer, such as silicone, which covers a conduction area 119 of the electrical contact 107.

For each electrical connector 103 and 105, the conduction area 119 designates the part of the longitudinal extension of the electrical contact 107, and by extension the part of the longitudinal extension of the electrical connector itself, in which the electrical connection is established with a bus bar or a cable, whether it is a plug-type or socket-type connector.

Thus, the annular insulator 111, which comprises the first annular insulator 111a and the second annular insulator 111b, externally covers the entire (radially external) surface of the electrical contact 107, with the exception of the part 108 of said surface which is intended to make contact with a complementary electrical contact of a complementary electrical connector (as shown in particular in FIG. 6).

The elastomer has high dielectric strength as well as resistance to high temperatures. The use of elastomer insulation allows limiting the existence of air gaps that can cause partial discharges.

In particular, such an elastomeric insulator can be compressed when the electrical connector is assembled, for example by means of clamping means included in the hollow cylindrical body of the electrical connector 109, to give the assembled electrical connector better sealing and reduce the potential presence of air gaps between the various pieces of said electrical connector.

In addition, as can be seen in FIG. 1, the second elastomeric insulator 111b rests on the first elastomeric insulator 111a so that it can compress the latter, particularly under the effect of thermal expansion, and thus reduce the presence of spaces (i.e. interstices) potentially filled with air.

More precisely, in the non-limiting example shown, the second annular insulator 111b lies behind the first annular insulator 111a (with respect to the connection area 117) with a flat face extending radially in contact with a complementary face of the first annular insulator 111a.

This configuration is particularly relevant to the non-limiting example described here in which the first annular insulator 111a comprises, in the connection area 117, two separate pieces 111aa and 111ab, of complementary shape, which fit into each other.

In the non-limiting example shown in FIG. 1 and in FIGS. 5 and 6 in particular, with regard to the electrical connector 103, the first piece 111aa of the first annular insulator 111a has a ring shape and the second piece 111ab of the first annular insulator 111a has a sleeve shape, complementary to the shape of the first piece 111aa on the one hand (and which therefore covers said first piece 111aa of the first annular insulator 111a of the electrical connector 103) and of the second piece 111ab of the first annular insulator 111a of the electrical connector 105 (and which therefore also covers said second piece 111ab of the first annular insulator 111a of the electrical connector 105).

Furthermore, in the case of the electrical connector 105, the first piece 111aa of the first annular insulator 111a is also ring-shaped, the internal diameter of which varies once (i.e. in a single position along the longitudinal extent of the piece), so as to form a support for a complementary shoulder formed in the second piece 111ab of the first annular insulator 111a.

In any case, the pressure exerted by the second annular insulator 111b on the first annular insulator 111a tends to keep the pieces 111aa and 111ab of the latter tight when the electrical connector 103 or 105 is assembled.

FIGS. 2, 3 and 4 show respectively the pieces 111aa and 111ab of the first annular insulator 111a for a male type electrical contact 107, before assembly of the electrical connector, the pieces 111aa and 111ab of the first annular insulator 111a for a female type electrical contact 107, also before assembly of the electrical connector, and finally, the male electrical contact 107 (in the left part of FIG. 4) and the female electrical contact 107 (in the right part of FIG. 4) covered by their respective annular insulators.

The division of the first annular insulator 111a into several pieces 111aa and 111ab facilitates its manufacture and the positioning of the insulator pieces during assembly of the electrical connector, in particular by allowing the positioning of the annular insulator pieces on either side of a shoulder of the electrical contact (as is the case in the example shown in FIG. 1) before tightening the assembly.

The electrical contact 107 may have a shoulder, i.e. a local modification of its cross-section, on which, because of its complementary shape, the first annular insulator 111a comes to bear so as to block the translation of the electrical contact 107 along the axis X.

In this case, the different pieces of the first annular insulator 111a come into contact, on either side of the shoulder, when the electrical connector 103 or the electrical connector 105 is assembled.

In all cases, for each annular insulator, the person skilled in the art will be able to adapt the shape and number of these pieces to facilitate the manufacture and assembly of an electrical connector, in particular as a function of the desired shape of the electrical contact and the hollow cylindrical body.

In addition, the shape and arrangement of the various pieces making up the first annular insulator 111a can be optimised to reduce the risk of partial discharge occurring, in particular by lengthening the creepage distances (represented by lines 123 in FIG. 5) located at the interfaces between these pieces.

In fact, at operating voltage, these lines must be sufficiently long to prevent localized electrical discharges from short-circuiting the insulating gap separating electrical contact 107 from the hollow cylindrical body 109.

FIG. 6 shows a particular embodiment in which each electrical connector 103 and 105 of the assembly 101 further comprises a flat gasket 125, which is also made of elastomer, and which is positioned at a surface of electrical contact 107 that extends radially, at the interface between the electrical contact 107 and the first annular insulator 111a.

In other embodiments, the number and position of the flat joints may be different, with the aim in all cases being to lengthen the creepage distances of the currents, but also to further limit the presence of air gaps at the interfaces between the various elements included in the electrical connector.

FIGS. 7 and 8 show yet another embodiment, in which the first annular insulator 111a additionally comprises, over all or part of its surface at the interface with the hollow cylindrical body 109, a layer 127 of an electrically conductive material. More specifically, FIG. 7 shows the pieces 111aa and 111ab of the first annular insulator 111a, suitable for male-type electrical contact, covered in part by a layer 127 of an electrically conductive material, while FIG. 8 shows pieces 111aa and 111ab of the first annular insulator 111a, suitable for female-type electrical contact, covered in part by a layer 127 of an electrically conductive material.

Advantageously, this type of deposit has the advantage of reducing the occurrence of partial discharge by placing the first annular insulator 111a and the hollow cylindrical body 109 at the same potential. In fact, the equipotentiality achieved by the presence of a conductive coating 127 on the outer surface of the pieces 111aa and 111ab reduces the risk of electric shocks.

Finally, FIG. 9 shows (for a socket-type electrical connector in the upper part and a plug-type electrical connector in the lower part) an embodiment in which the hollow cylindrical body 109 of the electrical connector (not shown) comprises, on a portion of its radially inner surface, a layer 129 of a polymer. For example, it could be a fluoropolymer material such as PFA (Perfluoroalkoxy), and here again, the advantage of such a deposit is that it reduces the presence of air gaps, which can be the cause of partial discharges.

Finally, the arrangement and the material used for the annular insulator, and in particular the first annular insulator, allow to considerably reduce the presence of air areas (vacuoles), increase the permittivity of the insulator and the resistance to high temperatures of the electrical connector as a whole.

1. An electrical connector for establishing an electrical connection with a complementary electrical connector, said electrical connector comprising:
a hollow cylindrical body extending around an axis of revolution;
at least one electrical contact positioned inside the hollow cylindrical body and extending parallel to the axis of revolution;
at least one annular insulator, extending parallel to the axis of revolution and being positioned radially between said at least one electrical contact and the hollow cylindrical body,
wherein said at least one annular insulator has a shape that is complementary to the shape of said at least one electrical contact and externally covers a surface of said at least one electrical contact, with the exception of a part of said surface of said at least one electrical contact that is configured to make contact with a complementary electrical contact of the complementary electrical connector,
said at least one annular insulator comprises a first annular insulator, made of a glass ceramic, covering a connection area of said at least one electrical contact,
and said at least one annular insulator further comprises a second annular insulator made of an elastomer and covering a conduction area of said at least one electrical contact.

2. The electrical connector according to claim 1, wherein said electrical connector is of the socket type and said at least one electrical contact is electrically connected to a bus bar or to an electrical cable, or said electrical connector is of the plug type and said at least one electrical contact is electrically connected to the electrical cable or to the bus bar.

3. The electrical connector according to claim 1, wherein said at least one electrical contact is of the male type.

4. The electrical connector according to claim 1, wherein said at least one electrical contact is of the female type.

5. The electrical connector according to claim 1, said electrical connector further comprising at least one flat elastomeric gasket, positioned at a second surface of said at least one electrical contact, and extending radially at the interface between said at least one electrical contact and said at least one first annular insulator.

6. The electrical connector according to claim 1, wherein said at least one first annular insulator further comprises, over all or part of its surface at the interface with the hollow cylindrical body, a layer of an electrically conductive material.

7. The electrical connector according to claim 1, wherein the glass ceramic from which the first annular insulator is made is a zero-porosity ceramic.

8. An assembly comprising two complementary electrical connectors according to claim 1.

9. An aircraft comprising the assembly according to claim 8.

10. The electrical connector according to claim 1, wherein the elastomer is silicone.
